(19) United States
(12) Patent Application Publication
(10) Pub. No.: US 2013/0009982 A1
(43) Pub. Date: Jan. 10, 2013

(54) APPARATUS AND METHOD FOR DISPLAYING AN IMAGE OF AN OBJECT ON A VISUAL DISPLAY UNIT

(76) Inventor: Daniel FONTIJNE, Amsterdam (NL)

(21) Appl. No.: 13/467,644

(22) Filed: May 9, 2012

(30) Foreign Application Priority Data
May 11, 2011 (NL) NL 2006762
May 11, 2011 (NL) NL 2007516

(51) Int. Cl. G09G 5/00

(52) U.S. Cl. 345/619

(57) ABSTRACT

Method and apparatus for displaying an image of an object on a visual display unit, wherein the image that is shown on the visual display unit depends on a parameter or parameters that is/are selected from the group comprising the 3-D orientation of the visual display unit, a position of a viewer's head or eyes in relation to the visual display unit, and a position of a light source or light sources at a location where the visual display unit is located, or a combination thereof.

The invention relates to an apparatus and method for displaying an image of an object on a visual display unit.

Such an apparatus and method is commonly known from the prior art and employed in the form of television sets, computer screens and similar devices. A problem with these known apparatuses and methods is that the impression rendered by the image or images of the object that is/are shown on the visual display unit barely ever provides a real-life sensation of the experience that looking at the true object provides. This particularly applies when showing images of non-Lambertian surface materials of an object, which may give an impression depending on the angle at which light impacts it and also depending on the angle at which one looks at the surface.

It is therefore an object of the invention to provide a method and apparatus in which the image of the object that is shown on the visual display unit provides an accurate match with looking at the true life object directly.

To promote the object of the invention a method and apparatus are proposed in accordance with one or more of the appended claims.

In a first aspect of the invention the image of an object that is shown on the visual display unit depends on a parameter or parameters that is/are selected from the group comprising the 3-D orientation of the visual display unit, a position of a viewer's head or eyes in relation to the visual display unit, and a position of a light source or light sources at a location where the visual display unit is located, or a combination thereof. Surprisingly it has proven to be possible to provide convincing images already by taking account of the 3-D orientation of the visual display unit. Improved results are attainable when also account is taken of a position of a viewer's head or eyes in relation to the visual display unit, and best results are achievable when still further account is taken of a position of a light source or light sources at a location where the visual display unit is located.

Whenever in this description mention is made of a light source or light sources this includes image based lighting, in which the entire environment is deemed to constitute a light source. Also reflections from the environment form a part thereof.

There are several viable ways in which the method of the invention can be implemented. One preferred embodiment has the feature that the image of the object that is shown on the visual display unit is calculated from a representation of the object, the calculation taking into account a parameter or parameters that is/are selected from the group comprising the 3-D orientation of the visual display unit, a position of a viewer's head or eyes in relation to the visual display unit, and a position of a light source or light sources at a location where the visual display unit is located, or a combination thereof.

In yet another embodiment the image of the object that is shown on the visual display unit is selected from a database comprising a series of images of the object, wherein the selected image provides a best fit with seeing the object in real life, taking into account a parameter or parameters that is/are selected from the group comprising the 3-D orientation of the visual display unit, a position of a viewer's head or eyes in relation to the visual display unit, and a position of a light source or light sources at a location where the visual display unit is located, or a combination thereof.

If in this embodiment one desires to limit the number of stored images, it is preferable that the image of the object that is shown on the visual display unit is calculated as an interpolation of images from the object that come closest to seeing the object in real life, taking into account a parameter or parameters that is/are selected from the group comprising the 3-D orientation of the visual display unit, a position of a viewer's head or eyes in relation to the visual display unit, and a position of a light source or light sources at a location where the visual display unit is located, or a combination thereof.

As mentioned above the invention is embodied in a method and in an apparatus that operates in accordance with said method. Such an apparatus for displaying an image of an object, is known to comprise a handheld computer with an integrated visual display unit. It is also known from the prior art that such a computer may be provided with (first) means to detect its 3-D orientation.

In accordance with the invention such an apparatus is embodied in a way that the computer is loaded with software that cooperates with said (first) means for detecting the 3-D orientation of the visual display unit to arrange that the image of the object that is shown on the visual display unit depends on the 3-D orientation of the visual display unit.

Preferably the apparatus is provided with second means to establish a position of a viewer's head or eyes in relation to the visual display unit, and that the software cooperates with said second means to arrange that the image of the object that is shown on the visual display unit depends on the established position of a viewer's head or eyes in relation to the visual display unit.

Still further preferably the apparatus is provided with third means to estimate a position of a light source or light sources at a location where the visual display unit is located, and that the software cooperates with said third means to arrange that the image of the object that is shown on the visual display unit depends on the estimated position of the light source or light sources.

It has shown possible to already provide smooth images of an object with a true live experience when the software operates in a continuous loop at a frequency of approximately 30 Hz. Preferably the operating frequency is 60 Hz.

The invention will hereinafter be further elucidated with reference to the drawing of an exemplary embodiment of the invention which is not limiting the appended claims.

In the drawing:

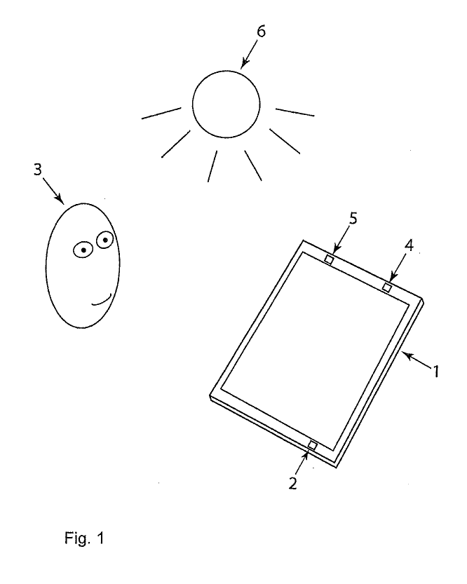

FIG. 1 shows a viewer looking at a tablet computer embodied with software in accordance with the invention;

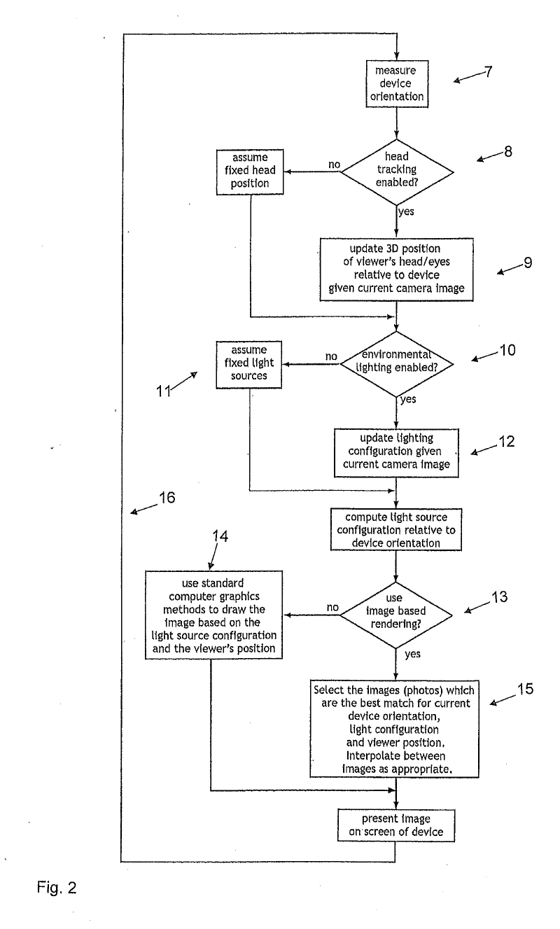

FIG. 2 shows a flow diagram embodying the method of the invention that may be implemented in the software for the handheld computer;

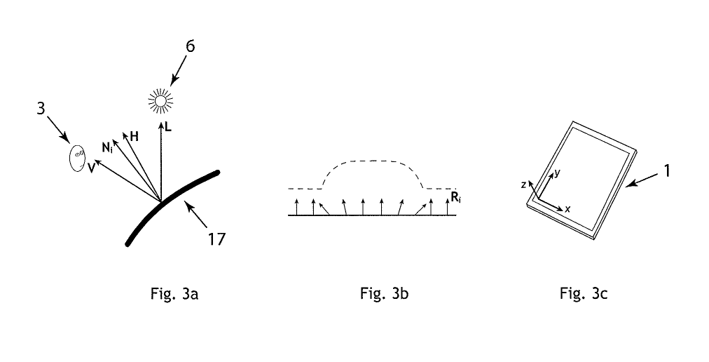

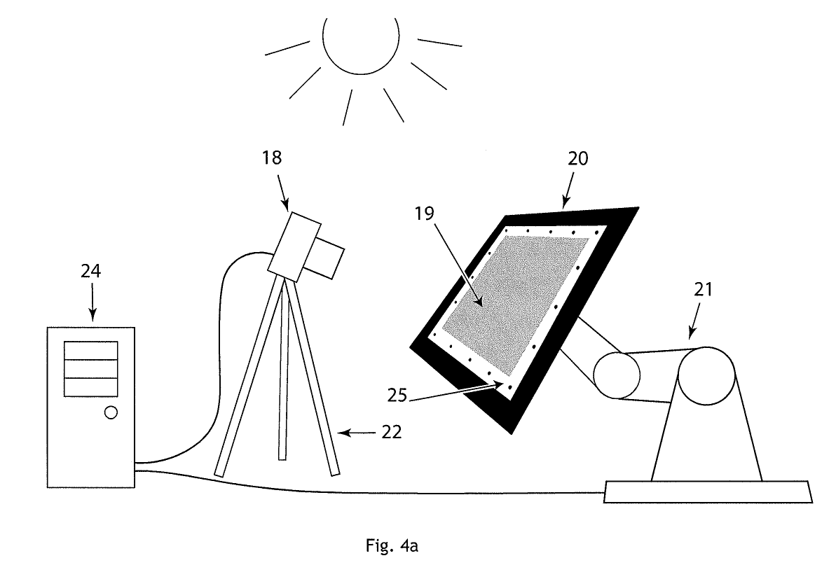

FIG. 3 shows graphs representing some mathematical considerations pertaining to a possible implementation of a method to draw an image based on a light source configuration and a viewer's position, which method forms part of the method according to the flow diagram of FIG. 2;

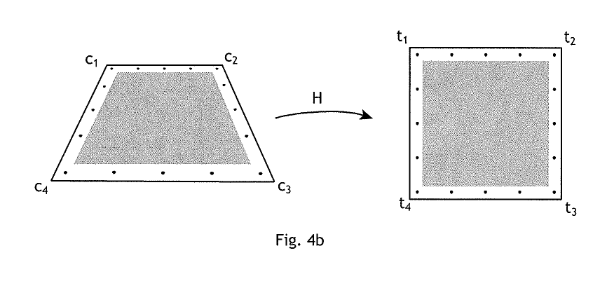

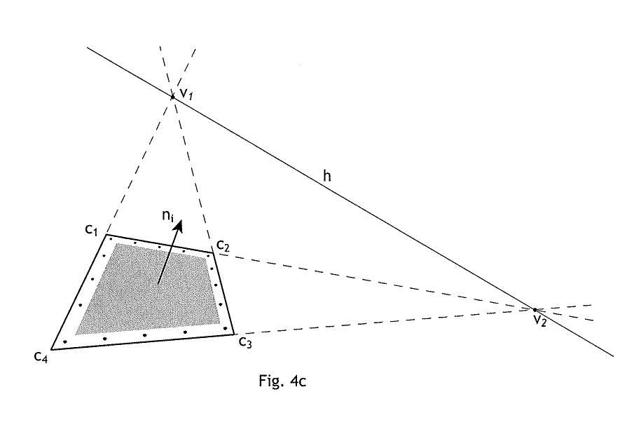

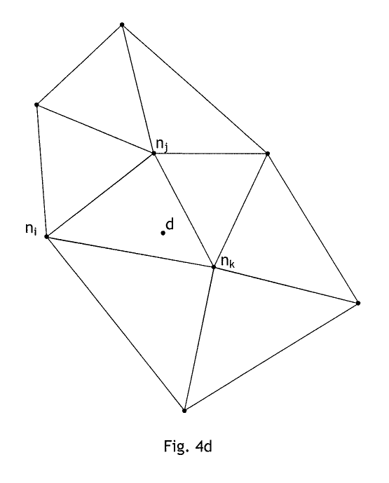

FIG. 4a shows a scheme for the collection of photographs of materials to be displayed on the handheld computer;

FIG. 4b shows the perspective transformation of a photograph of a sample material attached to a flat board to a fronto-parallel view of the board of FIG. 4a;

FIG. 4c shows computing the normal of the board that holds the material sample; and

FIG. 4d shows a Delaunay triangulation of the space of boards normal, used for interpolating between photographs in a possible implementation to provide a best match taking care of the device orientation, light configuration and viewer position.

Whenever in the figures the same reference numerals are applied, these numerals refer to the same parts

With reference first to FIG. 1, the apparatus of the invention for displaying an image of an object is shown and indicated with reference 1. This apparatus is preferably embodied as a handheld computer 1 with an integrated visual display unit at which a viewer 3 may be looking in a manner that is known per se. The computer 1 is preferably provided with first means to detect its 3-D orientation, which means are symbolized with the part that is carrying reference 2. The handheld computer 1 is further loaded with software that cooperates with said first means 2 for detecting the 3-D orientation of the visual display unit that forms part of the computer 1, in order to arrange that the image of the object that is shown on the visual display unit will depend on the 3-D orientation of the visual display unit of the computer 1.

Preferably the handheld computer 1 is provided with second means 4 to establish a position of a viewer's 3 head or eyes in relation to the visual display unit of the computer 1, and that the software cooperates with said second means 4 to arrange that the image of the object that is shown on the visual display unit depends on the established position of a viewer's 3 head or eyes in relation to the visual display unit/the computer 1.

Still further preferably the computer 1 is provided with third means 5 to estimate a position of a light source 6 or light sources at a location where the computer's visual display unit is located, and that the software cooperates with said third means 5 to arrange that the image of the object that is shown on the visual display unit depends on the estimated position of the light source 6 or light sources. This provides the possibility to improve the lighting and shading effects in the image shown.

Making reference now to FIG. 2, the method of the invention according to which the software preferably operates will now be elucidated.

In this method the image that is shown on the visual display unit depends on a parameter or parameters that is/are selected from the group comprising the 3-D orientation of the visual display unit, a position of a viewer's head or eyes in relation to the visual display unit, and a position of a light source or light sources at a location where the visual display unit is located, or a combination thereof.

As a first step square 7 relates to the determination of the 3-D orientation of the computer 1 and its visual display unit making use of the first means 2 as elucidated with reference to FIG. 1. Optionally then in diamond 8 it is established whether it is also possible to keep track of the viewer's 3 head or eyes making use of the second detecting means 4 shown in FIG. 1. In the affirmative case the position of the viewer's head or eyes can be taken into account in square 9 when determining the relative position of the visual display unit in relation to the viewer 3. In the negative case a fixed head position is assumed.

It is possible to track the head or eyes of the user 3 if a camera 4 facing the user 3 is integrated in the display device 1. This camera 4 embodies the second means to establish the position of a viewer's 3 head or eyes in relation to the visual display unit of the computer 1 facing the user. As an example for the manner in which the camera 4 can be used to detect the users face and keep track thereof thereof, reference is made to Rapid Object Detection using a Boosted Cascade of Simple Features [Lit. 13]. This technique is implemented in the OpenCV library http://sourceforge.net/projects/opencvlibrary/ [Lit. 14]. A different technique which also tracks the eye position and gaze direction is described in e.g. Visual Gaze Estimation by Joint Head and Eye Information [Lit. 15].

As a further option diamond 10 concerns the question whether the third means 5 shown in FIG. 1 are enabled for establishing or estimating the position of a light source 6. If the third means 5 are not enabled then the software operates as if a predetermined fixed position of a virtual light source applies as indicated in square 11. If however the third means 5 are enabled, square 12 indicates that account is being taken of the position of this light source 6 in the displaying of the image of the object on the visual display unit of the computer 1.

For environmental lighting it is possible to use a type of camera which is commonly integrated in known handheld computers. Such a camera is used to observe the intensity of the illumination of the environment, and this illumination intensity observation may be used to light the virtual material on the display of the handheld computer 1. Preferably a fish-eye camera with a near 180 degree field of view is used. If such a camera is not available on the handheld computer 1, individual images can be stitched into a panorama of the environment following e.g. Image Alignment and Stitching [Lit. 16]. Preferably, high dynamic range imaging techniques are used such as e.g. described in High Dynamic Range Imaging [Lit. 17].

If available, cameras integrated into the front and into the back of the handheld computer 1 should be used to get a full 360 degree representation of the environment. Light coming from the back-side of the handheld computer 1 may even be used to realize transparency effects as well as sub-surface scattering effects.

The panorama of the surroundings of the handheld computer 1 can be used to light the virtual material that is displayed visual display unit of the computer 1. The simplest environmental lighting effect is reflection of the environment in the virtual material on the display, but more advanced effects are possible such as those described in High Dynamic Range Imaging [Lit. 17].

Diamond 13 deals with the selection of the operational method in which the image to be displayed on the visual display unit of the handheld computer 1 is determined.

Square 14 relates to the embodiment in which the image that is shown on the visual display unit is calculated from a representation of the object, the calculation taking into account a parameter or parameters that is/are selected from the group comprising the 3-D orientation of the visual display unit, a position of a viewer's head or eyes in relation to the visual display unit, and a position of a light source or light sources at a location where the visual display unit is located, or a combination thereof.

Square 14 of the flow diagram in FIG. 2 may be realized in different ways. In the following an example of a possible algorithm is described in detail. The described method concerns the display of a plastic-like material with a relief (for example, the shape of a user interface button) embossed into it. It is possible however to implement Square 14 with many other known algorithms, see e.g. [Lit. 6, 7].

To simulate interaction of light with the plastic material, the lighting computations may be based on the Blinn-Phong shading model [Lit. 1]. This model is known as the default shading model used in computer graphics software libraries OpenGL [Lit. 2] and Direct3D [Lit. 3].

It is preferred to use such models that combine ambient, diffuse and specular shading terms. These terms are weighted by scalar factors wa, wd and ws, respectively. Other parameters are the red, green and blue (RGB) color vector C of the material and the scalar shininess s of the material. The RGB color vector W represents the color of the illumination, which for reasons of simplicity we assume to be white.

The local geometry involved in the shading calculations for each pixel is illustrated in FIG. 3a. For simplicity, a single light source 6 is assumed that is positioned above the material 17 to be visualized. The light is characterized by a unit direction vector L where its direction is from the material 17 towards the light 6. The position of the viewer 3 is characterized by a unit direction vector V, where its direction is from the material 17 towards the viewer 3.

The embossing in the plastic is represented by a normal map [Lit. 4]. This map defines the surface normal of the material to be displayed at each pixel on the visual display unit of the computer 1. FIG. 3b is an illustration of a cross section of a normal map representing a rounded button.

The orientation of the handheld computer 1 is represented by a 3×3 rotation matrix M. FIG. 3c shows the axes of the coordinate frame with reference to the handheld computer 1. The z-axis is orthogonal to the display of the computer 1, the x and y axes are aligned with the edges of the computer 1.

A new image to be displayed on the handheld computer 1 is calculated continuously. Each calculation then comprises the following steps:

1) Measure the device orientation M using first means 2 (see FIG. 1) to detect its 3-D orientation which is integrated into the handheld computer 1. Said first means 2 to detect said 3-D orientation may be a gyroscope or an accelerometer.

2) For each pixel i on the visual display unit of the computer 1, compute the intensity Ii as follows:
i) Retrieve the normal R corresponding to the pixel i from the normal map.
ii) Transform the normal to world coordinates:

N=M R.
iii) Compute diffuse intensity:

Id=max (N·L, 0).
iv) Compute the unit halfway vector:

H=(V+L)/|V+L|.
v) Compute specular intensity:

Is=pow(max(N·H, 0), s).
vi) Compute the pixel intensity by weighting and summing the terms:

Ii=wa C+wd Id C+ws Is W.
vii) Store the pixel intensity in image.

3) Present the computed image on the visual display unit of the handheld computer 1.

Square 15 relates to the embodiment in which the image that is shown on the visual display unit of the computer 1 is selected from a database comprising a series of images of the object to be displayed, wherein the selected image provides a best fit with seeing the object in real life, taking into account again a parameter or parameters that is/are selected from the group comprising the 3-D orientation of the visual display unit of the computer 1, a position of a viewer's head or eyes in relation to said visual display unit, and a position of a light source or light sources at a location where the visual display unit is located, or a combination thereof.

Preferably in this embodiment the image of the object that is shown on the visual display unit is calculated as an interpolation of images from the object that come closest to seeing the object in real life.

It is remarked that the calculus loop is closed with line 16 which reflects that the software embodying the method of the invention operates preferably in a continuous loop at a frequency of approximately 30 Hz, and more preferably 60 Hz.

One possible way of implementing Square 15 (image based rendering) of the flow diagram in FIG. 2 is presented below. This example consists of three steps: obtaining a representative set of photographs of the sample material to be displayed (such as a piece of fabric), pre-processing the photographs, and displaying the processed photographs on the display of the handheld computer 1.

### Obtaining Photographs

For image-based rendering, a set of representative photographs of the sample material to be displayed is required. These photographs capture the material under a large number of viewing angles and lighting conditions. It is remarked that such a set of photos is just one possible way to obtain the bi-directional texture function [Lit. 8] of the material to be displayed. In this example, only the viewing angle is varied. For reasons of simplicity, the lighting setup is kept static.

To obtain the photographs, FIG. 4a shows a high-resolution photo-camera 18. The photo-camera 18 must be calibrated (see e.g. [Lit. 9]), as the focal length, sensor size, sensor center and distortion of the camera 18 must be known in order to correctly process the photographs. A 3×3 camera calibration matrix K [Lit. 10] represents the focal length and sensor center of the camera 18.

For obtaining photographs, the sample material 19 is attached to a flat board 20. The board 20 is fixed to a motorized device 21 that can rotate the material 19 into the desired orientations. Such a motorized device 21 can be a generic robot arm, or a purpose-built device. The camera 18 is placed on a tripod 22 facing the board 20. Studio lighting 23 is used to light the sample material 19 as desired. A computer 24 controls the camera 18, the motorized device 21 and the illumination of the scene.

Software running on the computer 24 instructs the device 21 to rotate the board 20 to each of the desired orientations, after which the camera 18 makes a photograph. The photographs are stored for subsequent processing as described below.

### Processing the Photographs

The processing step described in this section extracts an area from each of the photographs, and aligns the extracted areas, as follows.

First, possible pin cushion or barrel distortion (known from the camera calibration) is corrected for in each photograph. In this example, the board 20 has high-contrast square edges 25 and high-contrast markers, as these will simplify subsequent-processing.

In the photograph, the square is imaged as a quadrilateral. The four corners ci of this quadrilateral (see FIG. 4b) are detected. The corners ci are represented by 2D homogeneous points (3-vectors). The quadrilateral is then mapped to a square, fronto-parallel view of the sample 19 area surrounded by the high contrast markers. For this purpose, a homography (a 3×3 matrix) H is computed that satisfies H ci□ti, where ti represents the homogeneous coordinates of a four corners square image T (the symbol □ denotes proportional to). The computed homography is used to transform each pixel in the sample area to the fronto-parallel view. The resulting image is stored in a texture image T.

Even though the corners of the square edge can be detected with high precision, alignment of different photographs may not be perfect. Thus high-contrast markers within the square edge 25 are used to further align the fronto-parallel views displayed in the photographs. To optimize all photographs at once, a bundle adjustment optimization procedure [Lit. 10] can be used.

The four corners ci are also used to compute the normal of the board in the photo-camera frame [Lit. 10], see FIG. 4c for illustration. Here, the four corners define two orthogonal directions in the plane of the board. The two vanishing points v1 and v2 of these directions are computed. The horizon of the board-plane is then computed as h=v1×v2, from which the normal ni of the board is computed as ni=transpose (K) h, where K is the 3×3 camera calibration matrix.

The processed images Ti including the normal ni of each image are stored. The following step describes how the material is displayed using these stored images.

### Displaying the Material

The view of the material displayed on the visual display unit of the handheld computer 1 is updated frequently, for instance 60 times per second. In this example the computer rotation is restricted to the x- and y-axes of the device (see FIG. 3c for an illustration of the computer coordinate frame). This implies that the device normal (the z-axis) can be used to encode the orientation of the handheld computer 1.

Each display step starts with measuring the handheld computer orientation M, a 3×3 rotation matrix. The last column in this matrix is the normal d (i.e., the z-axis in FIG. 3c) of the computer 1 in the world coordinate frame. The normal is used to retrieve the three neighbouring images Ti, Tj and Tk from the database of images. This can be done using a Delaunay triangulation [Lit. 11] of the space of board normals, see FIG. 4d. The Delaunay triangulation connects the board normals corresponding to each photograph to form a mesh of triangles. It is assumed the handheld computer normal d is contained by one of these triangles. This triangle is bounded by the normal ni, nj and nk corresponding to images Ti, Tj and Tk.

A weight w in the range [0, 1] is assigned to each image T based on the distance of each normal n to the device normal d, using the barycentric coordinates [Lit. 12]. The weights are such that wi+wj+wk=1.

The images Ti, Tj and Tk are retrieved from memory and interpolated using the weights (i.e., wi Ti+wj Tj+wk Tk). The interpolated image is subsequently presented on the display of the handheld computer 1.

### LITERATURE

[Lit. 1] James F. Blinn (1977). Models of light reflection for computer synthesized pictures. Proc. 4th annual conference on computer graphics and interactive techniques.
[Lit. 2] Dave Shreiner, The Khronos OpenGL ARB Working Group: OpenGL Programming Guide: The Official Guide to Learning OpenGL, Version 3.0 and 3.1, 7th Edition, Addison-Wesley, Jul. 21, 2009
[Lit. 3] Rob Glidden, Graphics Programming with Direct3D, Addison Wesley Longman, 1997
[Lit. 4] Krishnamurthy and Levoy, Fitting Smooth Surfaces to Dense Polygon Meshes, SIGGRAPH 1996
[Lit. 6] C. James D. Foley, Andries van Dam, Steven K. Feiner, John F. Hughes, Computer Graphics: Principles and Practice in. Addison-Wesley Professional; 2nd edition, 1995.
[Lit. 7] Tomas Akenine-Moller, Eric Haines, Naty Hoffman. A K Peters, Real-Time Rendering, 3rd edition, 2008.
[Lit. 8] Julie Dorsey, Holly Rushmeier, François Sillion. Digital Modeling of Material Appearance. The Morgan Kaufmann Series in Computer Graphics, Dec. 20, 2007.
[Lit. 9] Z. Zhang. A Flexible New Technique for Camera Calibration. IEEE Transactions on Pattern Analysis and Machine Intelligence, 22(11):1330-1334, 2000.
[Lit. 10] Richard Hartley and Andrew Zisserman. Multiple View Geometry. 2003, second edition, Cambridge University Press.
[Lit. 11] Mark de Berg, Otfried Cheong, Marc van Kreveld, Mark Overmars. Computational Geometry: Algorithms and Applications. 3rd edition. Springer 2008.
[Lit. 12] Christer Ericson. Real-Time Collision Detection. The Morgan Kaufmann Series in Interactive 3-D Technology, Jan. 5, 2005.
[Lit. 13] Rapid Object Detection using a Boosted Cascade of Simple Features. Paul Viola and Michael Jones. IEEE Conference on Computer Vision and Pattern Recognition, 2001.
[Lit. 14] OpenCV software library. http://sourceforge.net/projects/opencvlibrary/
[Lit. 15] Visual Gaze Estimation by Joint Head and Eye Information. Roberto Valenti and Theo Gevers. IEEE Conference on Computer Vision and Pattern Recognition, 2008.
[Lit. 16] Image Alignment and Stitching: a Tutorial. Richard Szeliski (Microsoft Research), 2006.
[Lit. 17] High Dynamic Range Imaging, Second Edition: Acquisition, Display, and Image-Based Lighting. Erik Reinhard, Wolfgang Heidrich, Paul Debevec, Sumanta Pattanaik, Greg Ward, Karol Myszkowski. Morgan Kaufmann; 2nd edition (Jun. 8, 2010).

1. Method for displaying an image of an object on a visual display unit, characterized in that the image of the object that is shown on the visual display unit depends on a parameter or parameters that is/are selected from the group comprising the 3-D orientation of the visual display unit, a position of a viewer's head or eyes in relation to the visual display unit, and a position of a light source or light sources at a location where the visual display unit is located, or a combination thereof.

2. Method according to claim 1, characterized in that the image of the object that is shown on the visual display unit is calculated from a representation of the object, the calculation taking into account a parameter or parameters that is/are selected from the group comprising the 3-D orientation of the visual display unit, a position of a viewer's head or eyes in relation to the visual display unit, and a position of a light source or light sources at a location where the visual display unit is located, or a combination thereof.

3. Method according to claim 1, characterized in that the image of the object that is shown on the visual display unit is selected from a database comprising a series of images of the object, wherein the selected image of the object provides a best fit with seeing the object in real life, taking into account a parameter or parameters that is/are selected from the group comprising the 3-D orientation of the visual display unit, a position of a viewer's head or eyes in relation to the visual display unit, and a position of a light source or light sources at a location where the visual display unit is located, or a combination thereof.

4. Method according to claim 3, characterized in that the image of the object that is shown on the visual display unit is calculated as an interpolation of images from the object that come closest to seeing the object in real life, taking into account a parameter or parameters that is/are selected from the group comprising the 3-D orientation of the visual display unit, a position of a viewer's head or eyes in relation to the visual display unit, and a position of a light source or light sources at a location where the visual display unit is located, or a combination thereof.

5. Apparatus for displaying an image of an object, comprising a handheld computer with an integrated visual display unit, wherein said computer is provided with first means to detect its 3-D orientation, characterized in that the computer is loaded with software that cooperates with said first means for detecting the 3-D orientation of the visual display unit to arrange that the image of the object that is shown on the visual display unit depends on the 3-D orientation of the visual display unit.

6. Apparatus according to claim 5, characterized in that it is provided with second means to establish a position of a viewer's head or eyes in relation to the visual display unit, and that the software cooperates with said second means to arrange that the image of the object that is shown on the visual display unit depends on the established position of a viewer's head or eyes in relation to the visual display unit.

7. Apparatus according to claim 5, characterized in that is provided with third means to estimate a position of a light source or light sources at a location where the visual display unit is located, and that the software cooperates with said third means to arrange that the image of the object that is shown on the visual display unit depends on the estimated position of the light source or light sources.

8. Apparatus according to claim 5, characterized in that the software operates in a continuous loop at a frequency of approximately 30 Hz.

9. Apparatus according to claim 6, characterized in that is provided with third means to estimate a position of a light source or light sources at a location where the visual display unit is located, and that the software cooperates with said third means to arrange that the image of the object that is shown on the visual display unit depends on the estimated position of the light source or light sources.

10. Apparatus according to claim 6, characterized in that the software operates in a continuous loop at a frequency of approximately 30 Hz.

11. Apparatus according to claim 7, characterized in that the software operates in a continuous loop at a frequency of approximately 30 Hz.

12. Apparatus according to claim 9, characterized in that the software operates in a continuous loop at a frequency of approximately 30 Hz.
